(19) United States
(12) Patent Application Publication
(10) Pub. No.: US 2004/0221239 A1
(43) Pub. Date: Nov. 4, 2004

(54) System and method for customizing an interactive training sequence

(76) Inventors: Michael Hachigian, Boise, ID (US); Arthur M. Caldwell, Boise, ID (US); C. Michael McLain, Boise, ID (US); Shane Winn, Boise, ID (US); Susan K. Lawrence, Eagle, ID (US)

Correspondence Address: HEWLETT-PACKARD COMPANY, Intellectual Property Administration, P. O. Box 272400, Fort Collins, CO, 80527-2400, US

(21) Appl. No.: 09/747,065

(22) Filed: Dec. 20, 2000

(51) Int. Cl. G06F 3/00

(52) U.S. Cl. 715/762; 715/708

(57) ABSTRACT

The present invention provides an improved system and method for customizing an interactive training sequence. The present invention includes one or more sets of predefined questions for gathering predefined information of the user, a customization module for customizing the training sequence responsive to the user response to the set of predefined questions, one or more login identifications for uniquely linking the custom training sequence to the user, a training module for playing the custom training sequence in a user understandable format when selected by the user. The custom training sequence is stored as a plurality of digital files, and each digital file is designated by a Uniform Resource Locator.

The present invention generally relates to an improved system and method for customizing an interactive training sequence. More specifically, it relates to a system and method for providing an interactive product service manual that allows for customization of training sequences linked to different login identifications.

Product service and support manuals are no longer in simple text format. In fact, it is becoming more common for product service manuals to contain a variety of features, such as video simulations and animations. The product service manuals are often quite extensive and complex; this is especially true within the computer industry. Because there is so much information contained in product service and support manuals, it can be difficult to find what the user wants, resulting in waste of valuable time and user frustrations. Furthermore, because technology changes so quickly in the computer industry, these product service manuals require frequent changes and updates.

### BRIEF SUMMARY OF THE INVENTION

The present invention provides an improved system and method for customizing an interactive training sequence. In one embodiment, the present invention includes one or more sets of questions for gathering information from the user, a customization module for customizing the training sequence responsive to the user response to the set of predefined questions, one or more login identifications for uniquely linking the custom training sequence to the user, a training module for playing the custom training sequence in a user understandable format when selected by the user. The custom training sequence is stored as a plurality of digital files, and each digital file is designated by a Uniform Resource Locator.

In another embodiment, the customization system and method of the invention further provide an interactive product service manual that includes a documentation module for displaying documents of said manual in a user understandable format responsive to user selection, a simulator module for playing at least one interactive animated simulation in a user understandable format responsive to user selection, a customization module for customizing an interactive training sequence responsive to a user response to a set of predefined questions, and a training module for playing said customized interactive training sequence in a user understandable format responsive to user selection.

### DESCRIPTION OF THE DRAWINGS

FIG. 1 is an exemplary diagram of a network system in which the present invention can be implemented;

FIG. 2A-2C is a flowchart illustrating overall functions of one embodiment of the present invention;

FIG. 3 embodiment of the present invention;

FIG. 3 is a preferred main menu home page;

FIG. 4 is a preferred default page of the documentation module;

FIG. 5 is a preferred default page of the guided tour module;

FIG. 6 is an exemplary benefit page linked from the guided tour default page shown in FIG. 5;

FIG. 7 is an exemplary simulation page of the simulator module;

FIG. 8 is an exemplary practice exam page of the practice module;

FIG. 9 is a preferred information page of the information module;

FIG. 10 is a preferred feedback page of the feedback module;

FIG. 11 is a preferred login page of the training module;

FIG. 12 is an exemplary customization page of the customization module; and,

FIG. 13 is an exemplary page of a custom training sequence.

### DETAILED DESCRIPTION

Broadly stated, the present invention is directed to an improved system and method for customizing an interactive training sequence. The present invention allows users to customize their training sequence. The progress of the training sequence can be saved and identified by a unique login identification, which allows users to return to where they left off in the last training sequence. Different modules provide the user a variety of ways to understand the service and setup needs of the product. For example, the users can display documents, simulations and their custom training sequences.

The present invention preferably utilizes HyperText Markup Language (“HTML”), JAVA scripts, and Shockwave Flash Objects. Because all these selected items can be used on most available web browsers, the selected items are most flexible for the implementation of the present invention. Furthermore, the content of the product service manual is stored in different digital files, and each of these digital files is designated by a Uniform Resource Locator.

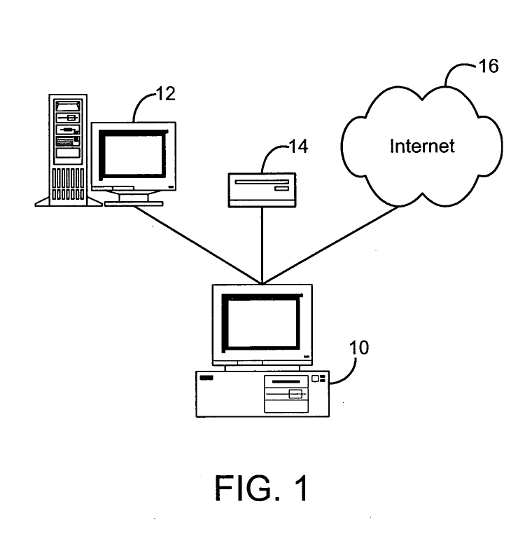

Turning now to FIG. 1, an exemplary diagram of a network system is shown. The present invention can be implemented in a variety of ways. The service product manual can be displayed on a computer 10, which can be any type of computer that has a software program that can display the manual in a user understandable manner. The service product manual can be stored in any medium that the computer 10 has access to, such as a network server 12, a CD drive 14, and an Internet server 16. Because, among other things, the manual can be updated easily and the wide availability of the Internet, the present invention is preferably implemented using the Internet. Although three possibilities are shown as an example, the present invention can be implemented in many different ways, and other implementations are contemplated and within the scope of the present invention.

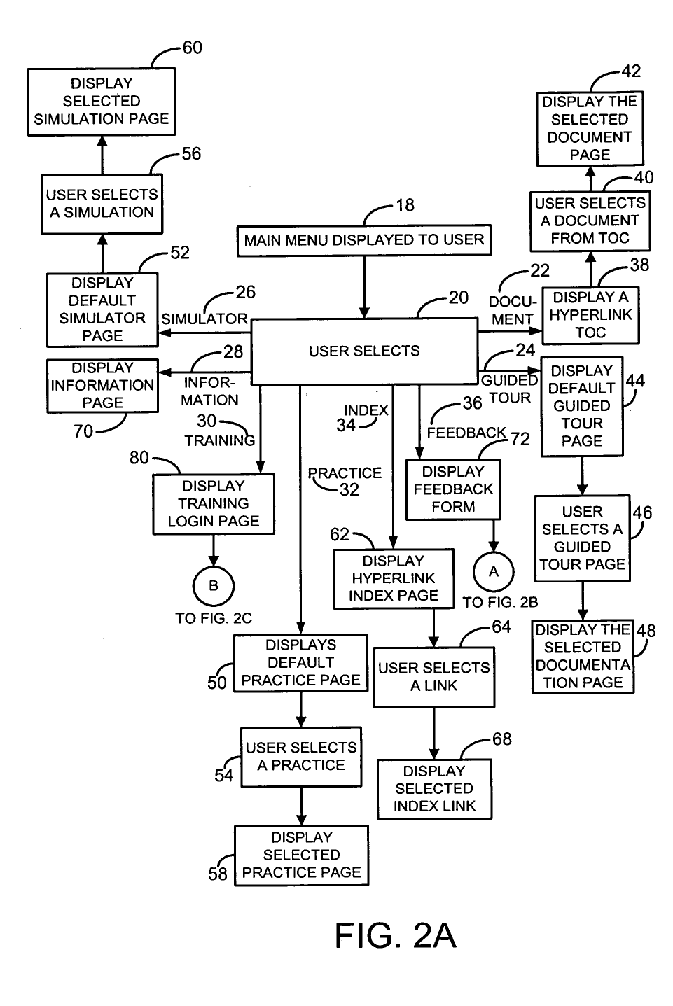

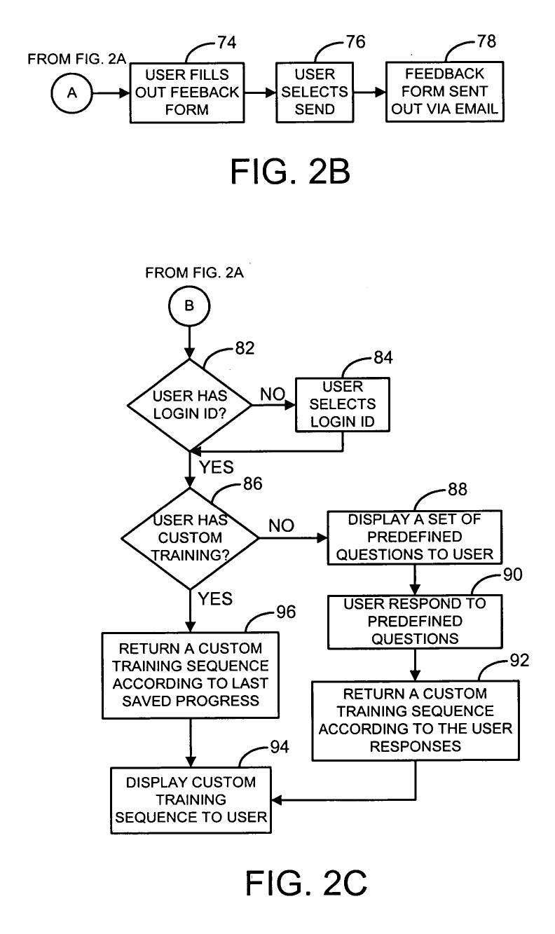

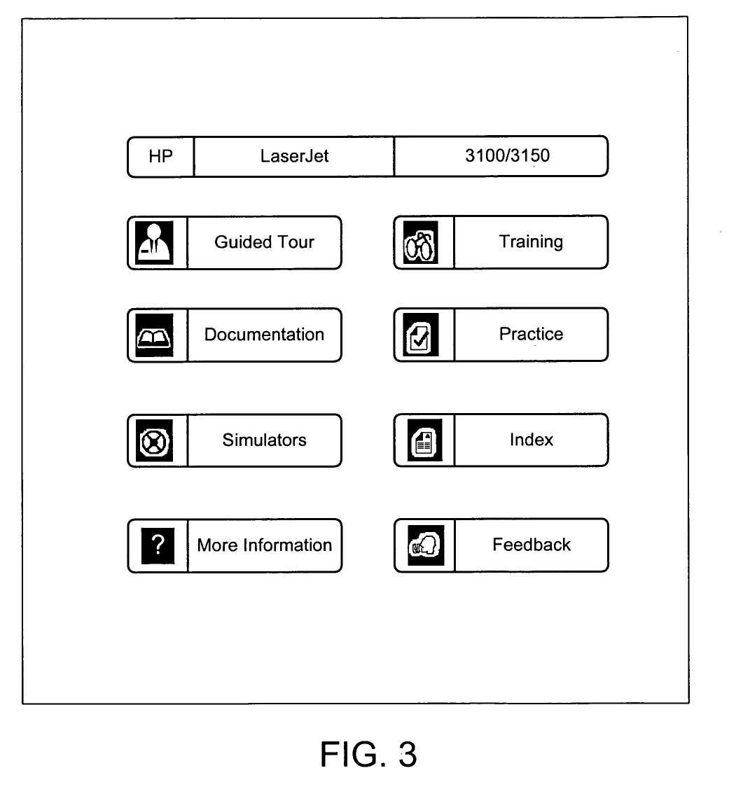

A flowchart illustrating the overall functions of one embodiment of the present invention is shown in FIG. 2A. A flowchart of the feedback module and the training module with the customization module are shown in greater detail in FIGS. 2B and 2C, respectively. A main menu is displayed to the user (block 18), which includes eight (8) options for the user to choose from (block 20). More specifically, the main menu page includes a documentation module 22, a guided tour module 24, a simulator module 26, an information module 28, a training module 30, a practice module 32, an index module 34, and a feedback module 36. The preferred main menu page is shown in FIG. 3, and as shown, there are the 8 options. When a user wishes to select one of the options, the user just clicks the selected option on the main menu.

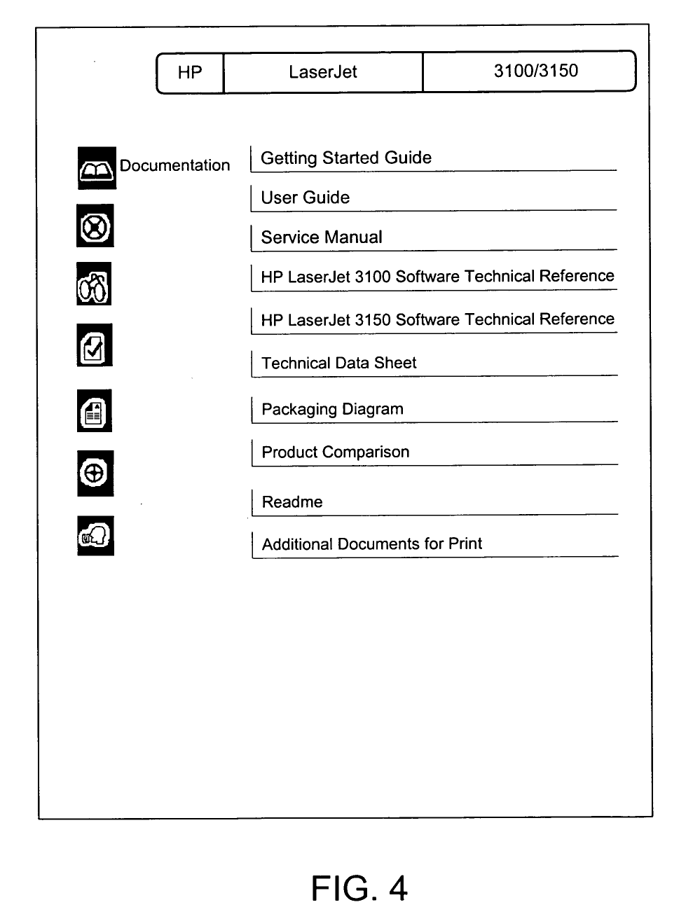

If the user selects the documentation module 22 (block 20), a hyperlink table of contents of the documents is displayed to the user (block 38). The user selects a document from the table of contents (block 40), and the selected document page is displayed to the user (block 42). The preferred table of contents, shown in FIG. 4, provides a list of documents that the user can select by clicking on the selected document. In addition, the 8 options are also included on the left of the table of contents for easier navigation of the product service manual. Again, the user selects another option by simply clicking on the icons provided. In fact, the user will see a label of the icon if the user moves the pointer over the icons without clicking it. As illustrated, a lot of information is provided to the user, but the information is not displayed unless there is an indication that the user is interested.

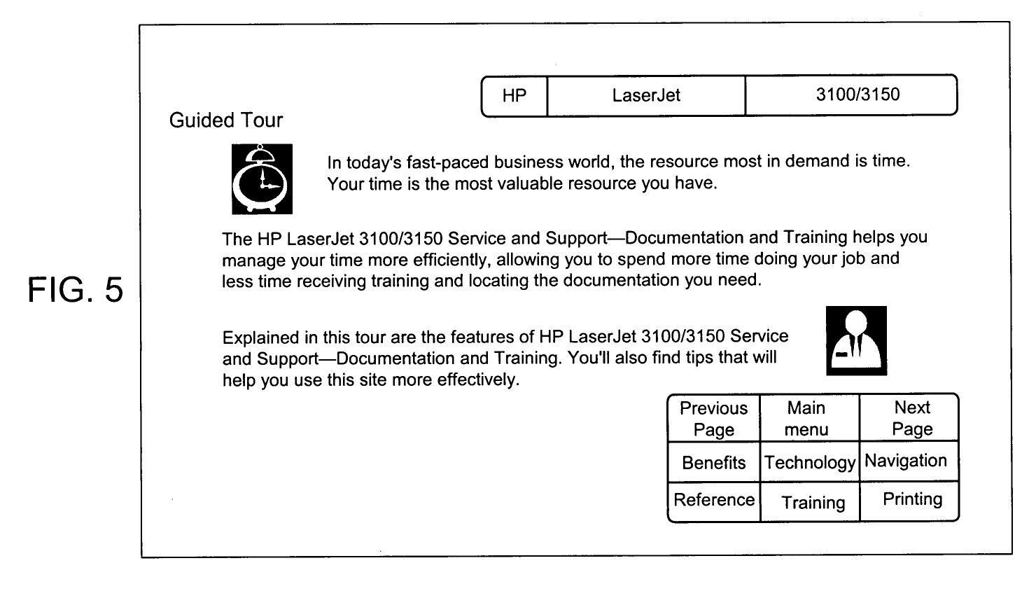

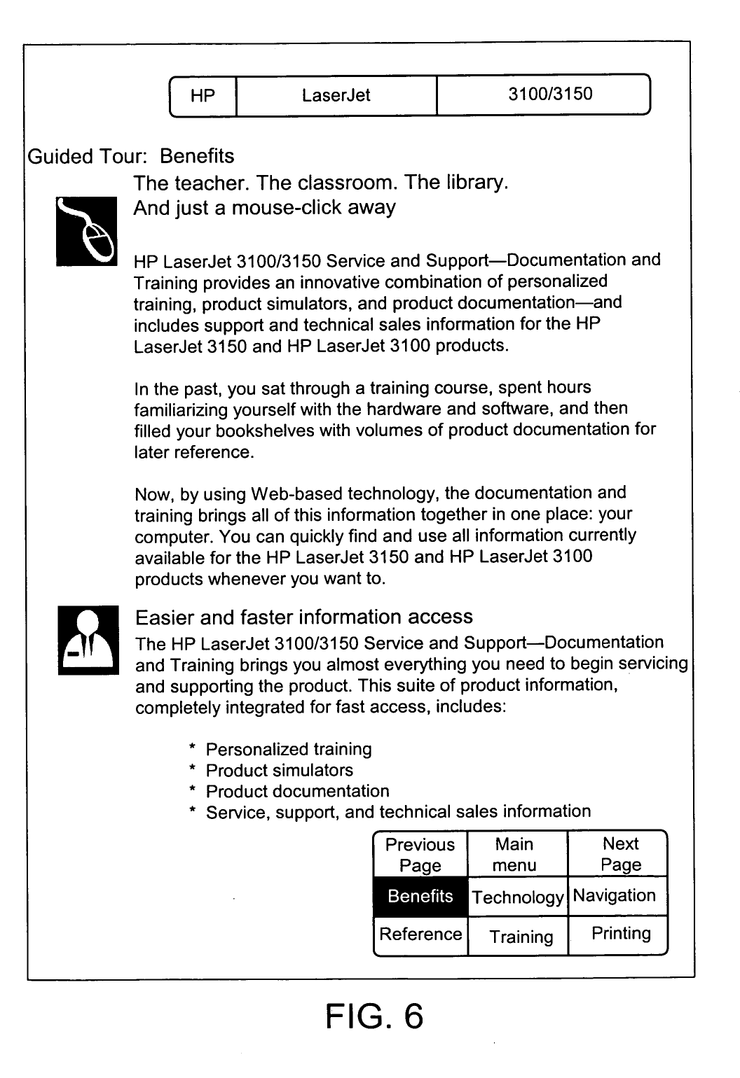

Similarly, when the guided tour module 24 is selected (block 20), a default guided tour page is returned and displayed to the user (block 44). The user selects a guided tour page (block 46), which is then displayed to the user (block 48). The preferred default guided tour page is shown in FIG. 5 as an example. The navigation buttons are located on the lower right hand corner of the page, which can be selected by clicking on them. For example, if a user clicks on the benefit button, the benefit page is displayed to the user (shown in FIG. 6). However, there are no limitations in the design and appearance of any of the pages included in the manual as long the function of the page is captured. These other various implementations are contemplated and are within the scope of the present invention.

Again, when the user selects the training module 30 or the simulator module 26 (block 20), the default practice page (block 50) or the default simulator page (block 52) is displayed to the user. The user selects a practice (block 54) or a simulation (block 56), and the selected practice (block 58) or simulation is displayed to the user (block 60). The index module 34 follows similar steps, except the default index page is a hyperlink index page (block 62). A link is selected (block 64) and displayed to the user (block 68).

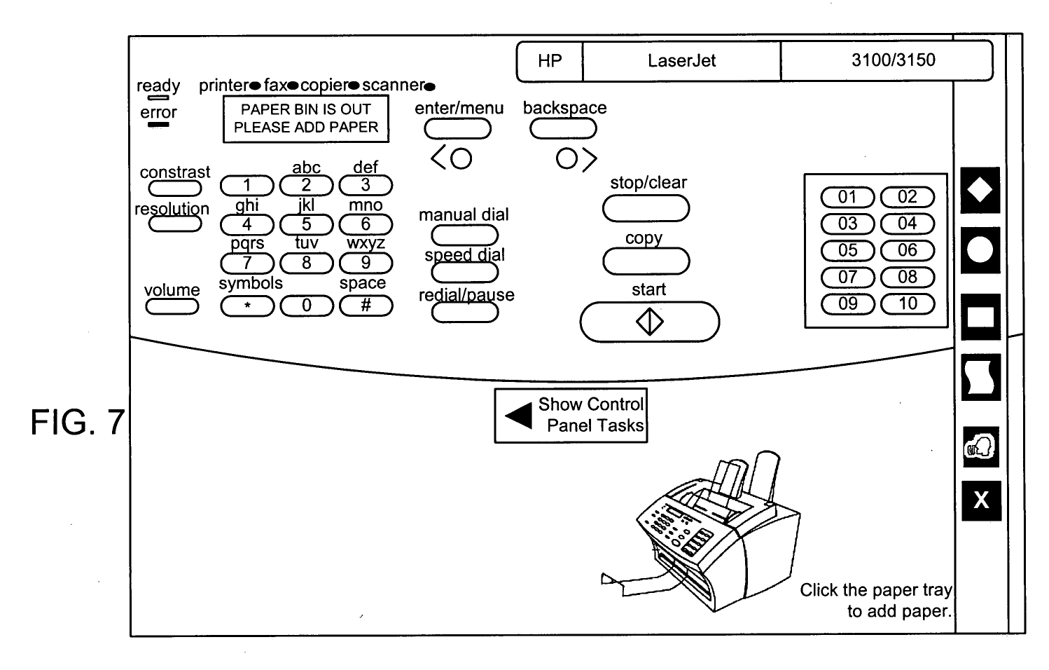

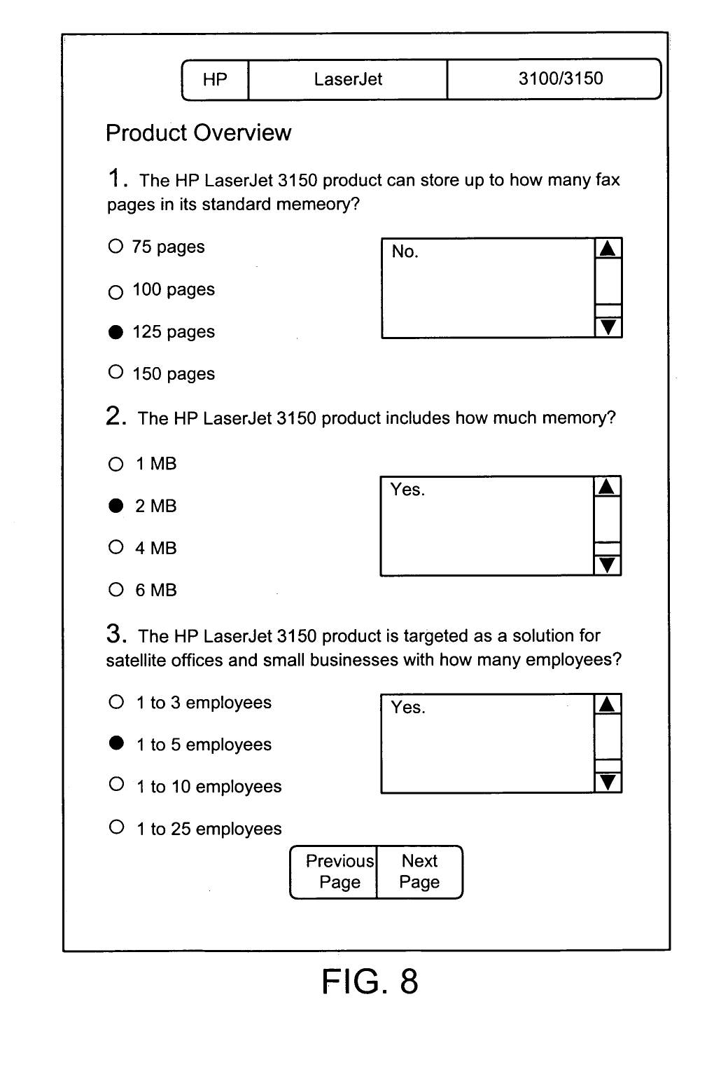

An exemplary simulation of a control panel of an HP LaserJet Fax Printer is shown in FIG. 7. It is called a simulation because it is not simply text files. In the control panel example, the user can click on any of the buttons shown, and the simulation is designed to react interactively to the clicks depending upon what buttons are pushed. In other words, it reacts just like the real control panel would. Preferably, specific instructions are provided sequentially in order to provide an interactive manual that requires user responses and participation. Therefore, at some point in the sequence, the next sequence will not be displayed to the user unless there is a user response. Again, navigation buttons are provided to the user on the right side of the page for convenience. The practice module, on the other hand, is similar to a test form. An exemplary practice page is shown in FIG. 8. In this example, the clicking of each answer choice gives a different message in the box next to the multiple choices.

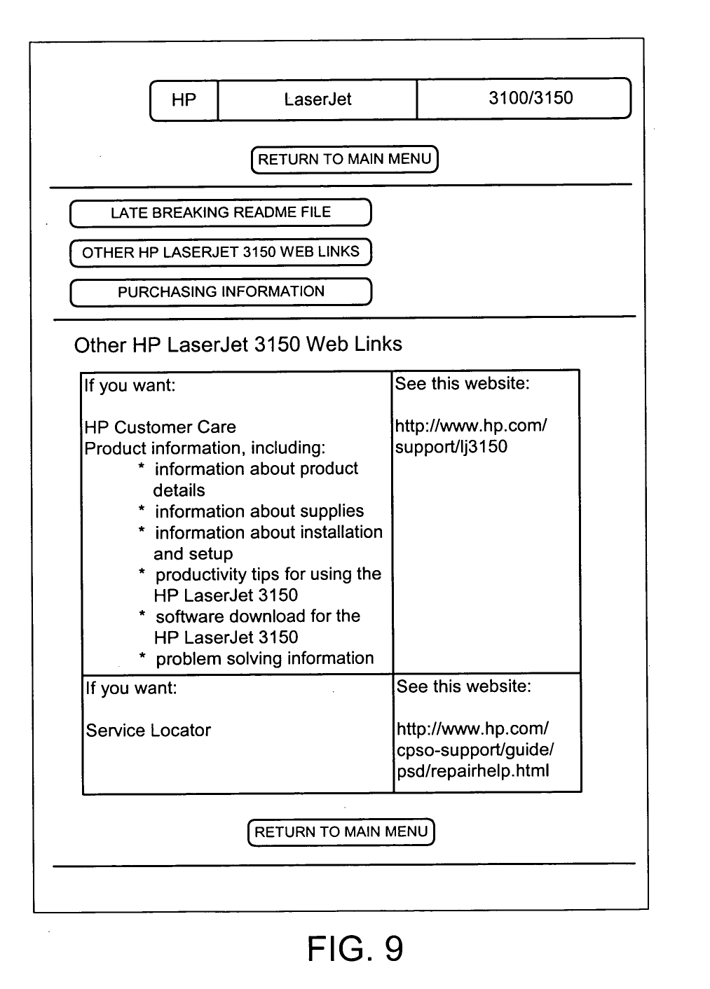

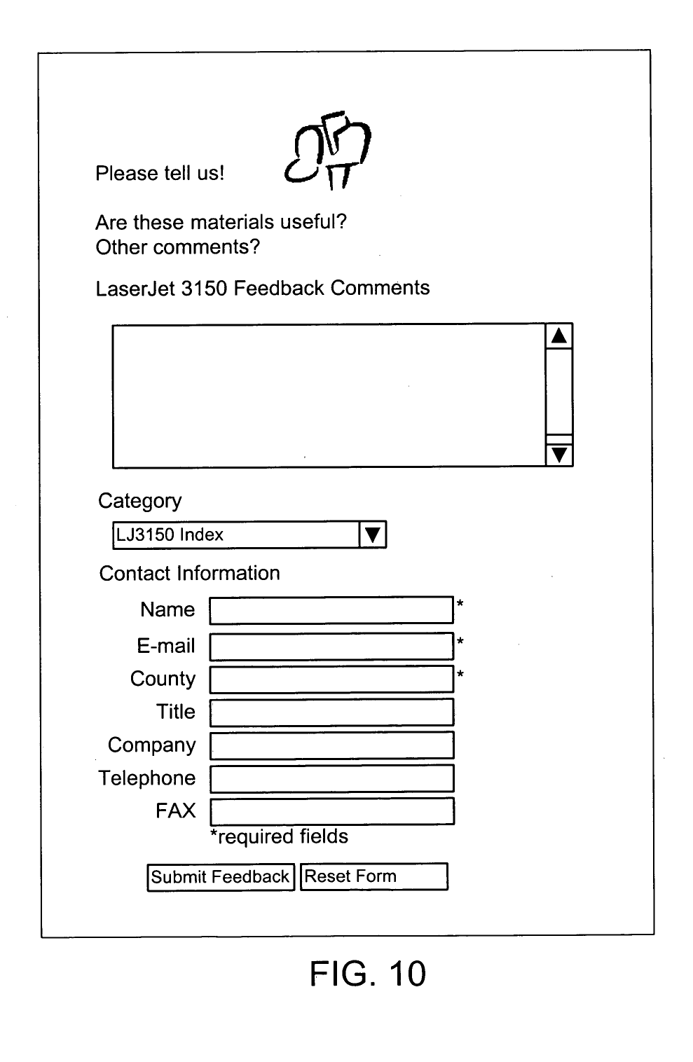

What remains is the information module 28, the feedback module 36 and the training module 30. An information page containing additional information on other links and contacts is displayed (block 70) when the user selects the information module 28 (block 20). An exemplary information page is shown in FIG. 9. Similarly, a feedback form is displayed (block 72) when the user selects the feedback module 36 (block 20), and an example of the form is shown in FIG. 10. However, the feedback module includes an additional feature, which continues in FIG. 2B. The user first fills out the feedback form (block 74) and selects send (block 76). The form is then sent preferably via email to a predefined email address (block 78).

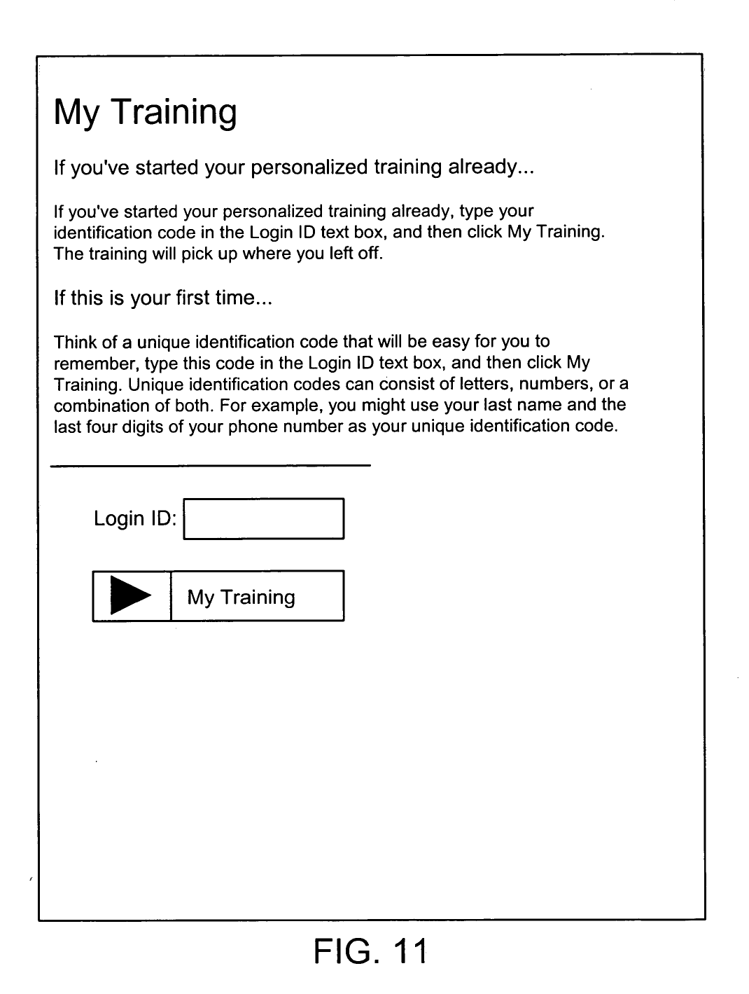

With respect to the training module, when it is selected (block 20), a training login page (shown in FIG. 11) is displayed to the user (block 80), and it is determined whether the user has a login ID (block 82) (see FIG. 2C). The user must provide a login ID (block 84) if the user does not have one (block 82). Once the user logs in with the login identification (block 82), it is determined whether the user already has a custom training sequence linked to the login ID provided by the user (block 86).

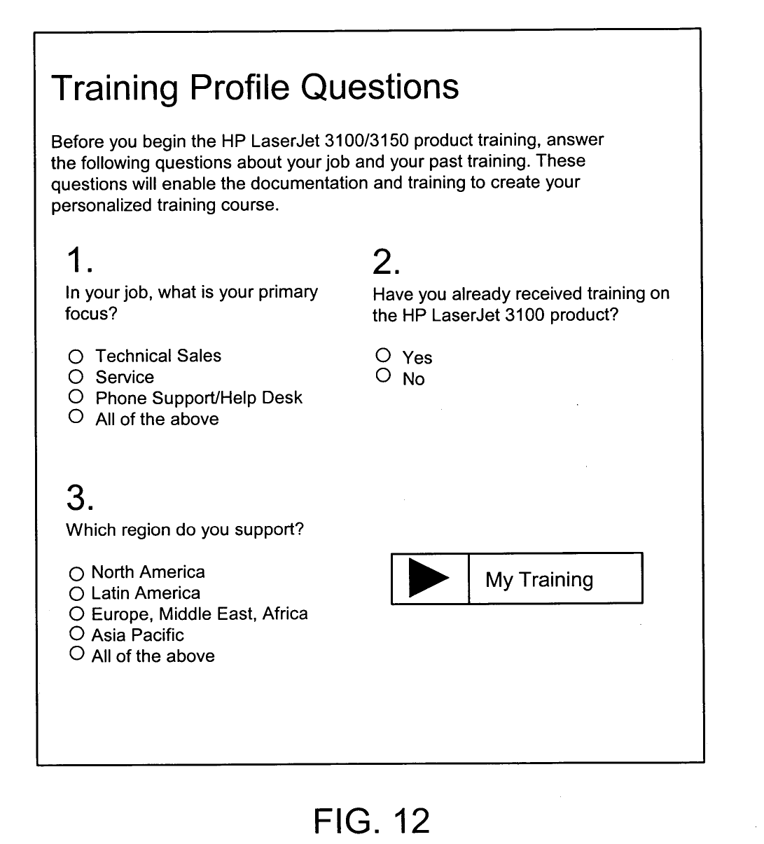

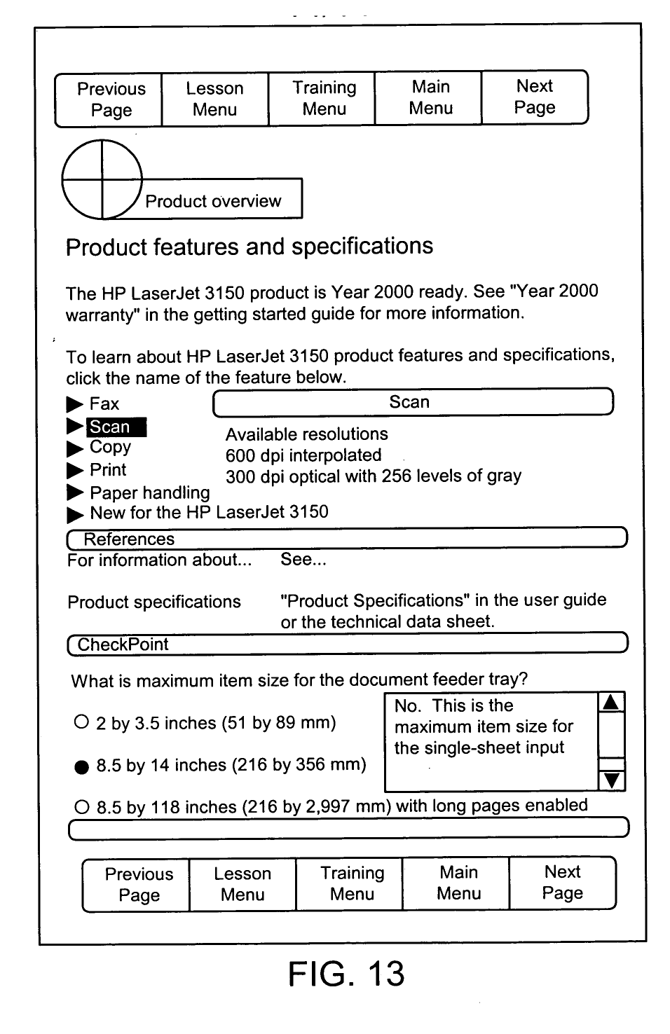

If it is determined that the user does not yet have a custom training sequence (block 86), a set of predefined questions is displayed to the user (block 88). An example of the predefined questions page is shown in FIG. 12. Of course, these questions can be varied depending on the need of the customization. The user must then respond to the predefined questions (block 90), and a custom training sequence according to the responses from the user is returned (block 92) and displayed to the user (block 94). Likewise, if the user already has a custom training sequence linked to the login identification (block 86), a custom training sequence is returned to the user (block 96). In this case, the custom training sequence is displayed from the last saved progress (block 94), such as an exemplary page shown in FIG. 13. As shown, a body of text relating to the desired topic is included with one or more test questions, which the user may complete before the next page is shown. Similar to the simulation page, at some point in the training sequence, a user response is required before the next sequence is played to the user. If the user exits a sequence, the last progress of the sequence is saved so that the user can start from the point where the user exited the training sequence, rather than the beginning of the sequence.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

1. A system for providing product service and support information to a user, including automatically customizing an interactive training sequence, comprising:
said system presenting at least one set of predefined questions to the user for gathering information about the user;
a customization module for customizing the content of said training sequence responsive to the users'responses to said set of predefined questions;
said system storing at least one login identification supplied by the user for uniquely linking said customized training sequence to the user;
a training module for playing said customized training sequence in a user understandable format responsive to user selection;
wherein said customized training sequence is stored as a plurality of digital files, each designated by a Uniform Resource Locator.

2. Cancelled.

3. A system as defined in claim 1 wherein said training module saves the progress of said customized training sequence linked to said login identification.

4. A system as defined in claim 3 wherein said training module retrieves said customized training sequence according to said last saved progress responsive to user login of said login identification.

5. A method of operating a computer system for automatically customizing an interactive training sequence that provides product service and support information to a user, said method comprising the steps of:
providing a set of predefined questions to the user responsive to the user providing a unique login identification;
the computer system receiving user responses to said set of predefined questions; and,
the computer system returning a customized training sequence according to said user responses from said set of predefined questions;
wherein said custom customized training sequence is linked to said unique login identification.

6. The method according to claim 5 further comprising the step of saving said customized training sequence linked to said unique login identification.

7. The method according to claim 5 further comprising the step of saving the progress of said customized training sequence linked to said unique login identification.

8. The method according to claim 7 further comprising the step of retrieving said customized training sequence according to said last saved progress responsive to user login of said unique login identification.

9. An interactive computer system for providing product service information to a user, the system normally operating without human involvement, comprising:
a documentation module for displaying the product service information in a user understandable format responsive to user selection;
a simulator module for playing at least one interactive animated simulation in a user understandable format responsive to user selection;
a customization module for customizing an interactive training sequence responsive to a user response to a set of predefined questions; and,
a training module for playing said customized interactive training sequence in a user understandable format responsive to user selection.

10. A system as defined in claim 9 wherein said product service information is stored as a plurality of digital files, wherein each said digital file is designated by a Uniform Resource Locator.

11. A system as defined in claim 9 further comprising:
a guided tour module for displaying a series of introductory documents of said product service information in a user understandable format responsive to user selection;
a feedback module for allowing users to send comments;
a practice module for displaying practice exam forms in a user understandable format responsive to user selection;
an index module for displaying a hyperlink index of said service information in a user understandable format responsive to user selection; and,
an information module for displaying additional contact information relating to said service information in a user understandable format responsive to user selection.

12. A system as defined in claim 9 is a web based online product service information.

13. A system as defined in claim 9 wherein part of said at least one interactive animated simulation requires user response before the next sequence is played to the user.

14. A system as defined in claim 9 wherein part of said customized training sequence requires user responses before the next sequence is played to the user.

15. A system as defined in claim 9 wherein said documentation module includes a hyperlink table of contents for said documents included in said documentation module.

16. A system as defined in claim 9 wherein said simulator module includes a hyperlink table of contents for said at least one interactive animated simulation.

17. A system as defined in claim 9 wherein said customization module prompts the user to select a unique login identification and to respond to said set of predefined questions.

18. A system as defined in claim 17 wherein said customization module returns a custom training sequence according to user responses from said set of predefined questions, and said custom training sequence is linked to said unique login identification.

19. A system as defined in claim 18 wherein said customization module saves said custom training sequence linked to said unique login identification.

20. A system as defined in claim 18 wherein said customization module saves all said Uniform Resource Locators for said custom training sequence linked to said unique login identification.

21. A system as defined in claim 18 wherein said customization module saves the progress of said custom training sequence linked to said unique login identification.

22. A system as defined in claim 18 wherein said customization module allows the user to retrieve said custom training sequence with login of said unique login identification.

23. A system as defined in claim 21 wherein said customization module allows the user to retrieve said customized training sequence with login of said unique login identification, and said training sequence will be played according to said last saved progress.

24. A system as defined in claim 11 wherein said feedback module is configured to send comments over the Internet.

25. A system as defined in claim 11 wherein said practice module is configured to indicate whether the user choices for said exam form is correct or incorrect.

26. Cancelled

27. A computer system for providing an interactive product service manual, said system normally operating without human intervention, said system comprising:
means for displaying documents of said manual responsive to user selection;
means for playing at least one interactive animated simulation responsive to user selection;
means for customizing an interactive training sequence responsive to user response to a set of predefined questions; and,
means for playing said customized interactive training sequence responsive to user selection.

28. A method for providing an interactive product service manual having at least one documentation, at least one interactive animated simulation, and at least one training sequence customized by the user, said method being executed by a computer system connected to a LAN and comprising the steps of:
providing hyperlinks to the content of said interactive product service manual;
displaying said at least one documentation responsive to a user selection;
playing said at least one interactive animated simulation responsive to a user selection;
customizing an interactive training sequence responsive to user responses to a set of predefined questions; and,
playing said customized interactive training sequence responsive to user selection.
